(19) United States
(12) Patent Application Publication
(10) Pub. No.: US 2020/0283623 A1
(43) Pub. Date: Sep. 10, 2020

(54) PROCESS FOR PREPARING THERMOPLASTIC RESIN

(71) Applicant: DSM IP Assets B.V., Heerlen (NL)

(72) Inventors: Katarina TOMIC, Echt (NL); Angelika SCHMIDT, Echt (NL); Veerag MEHTA, Echt (NL); Helen LENTZAKIS, Echt (NL)

(21) Appl. No.: 16/652,526

(22) PCT Filed: Oct. 2, 2018
(86) PCT No.: PCT/EP2018/076805

§ 371 Date: Mar. 31, 2020

(30) Foreign Application Priority Data
Oct. 2, 2017 (EP) 17194424.2

(51) Int. Cl. C08L 67/07

(52) U.S. Cl. CPC C08L 67/07; C08L 2205/03

(57) ABSTRACT

The invention relates to a process for preparing a thermoplastic resin comprising the following steps: a) mixing: •a thermoplastic copolyester (A) having a shore A hardness of less than 95; and •a silicone elastomer (B) comprising a polydiorganosiloxane gum having a plasticity of at least 30 and having on average at least 2 alkenyl groups per polymeric chain and optionally a reinforcing agent in the range of 0 to 50 wt % based on the weight of the polydiorganosiloxane gum; and •a radical initiator (C) in an amount of 0.01 to 5 wt % based on the weight of the silicone elastomer; and •optionally an adhesion additive (D); wherein the weight ratio of the silicone elastomer to the thermoplastic copolyester (B:A) is from 15:85 to 99.5:0.5; b) dynamically vulcanizing the silicone elastomer in the thermoplastic copolyester at an elevated temperature. The invention also relates to a thermoplastic resin itself.

The invention relates to a process for preparing a thermoplastic resin, in particular soft thermoplastic resins, and the invention also relates to a thermoplastic resin and goods comprising the resin. Soft thermoplastic resins are nowadays employed in many applications such as wearables, straps etc. and it is a desire to have still softer grades, without compromising the mechanical properties. Furthermore, it is also required that the applications exhibit sufficient scratch resistance and tear resistance.

Soft thermoplastic resins and in particular thermoplastic copolyesters are known WO2016150699, but these are usually limited to a particular softness and softness is often obtained by the addition of plasticizers. However, plasticizers are known to bloom out and the applications may become less soft while aging. Some plasticizers are also considered toxic and skin contact with bloomed out plasticizers is unwanted. In an attempt to solve this issue, blending in of siloxanes has been studied. However, only a limited amount of siloxanes can be blended into thermoplastic copolyesters, which limits the attainable softness. If high amounts are used, insufficient mechanical properties are attained. Another attempt was made to incorporate siloxanes by hydrosilation as for example disclosed in WO03035764. This solution, however, exhibited insufficient tear resistance and also the flow of the composition proved to be insufficient, which limits the design freedom in applications.

It is thus an object to provide a process and a thermoplastic resin which combines softness, sufficient mechanical properties such as sufficient tear resistance, and sufficient scratch resistance.

Surprisingly, this has been achieved by a process for preparing a thermoplastic resin comprising the following steps:
a) mixing:
   a thermoplastic copolyester (A) having a shore A hardness of less than 95; and
   a silicone elastomer (B) comprising a polydiorganosiloxane gum having a plasticity of at least 30 and having on average at least 2 alkenyl groups per polymeric chain and optionally a reinforcing agent in the range of 0 to 50 wt % based on the weight of the polydiorganosiloxane gum; and
   a radical initiator (C) in an amount of 0.01 to 5 wt % based on the weight of the silicone elastomer; and
   optionally an adhesion additive (D);
      wherein the weight ratio of the silicone elastomer to the thermoplastic copolyester (B:A) is from 15:85 to 99.5:0.5;
b) dynamically vulcanizing the silicone elastomer in the thermoplastic copolyester at an elevated temperature.

The obtained thermoplastic resin exhibits a softness which may be better as compared to a blend of thermoplastic copolyester with siloxanes, and a tear strength which is surprisingly better as compared to a thermoplastic copolyester in which the siloxane is incorporated by hydrosilation. Also scratch resistance showed to be better as compared to a blend of thermoplastic copolyester and plasticizer. This has been exemplified by examples.

U.S. Pat. No. 8,779,073 discloses a method to prepare a thermoplastic resin in which resins having a T_{g} of 95° C. or greater are employed. This method employs a similar silicone elastomer, and radical initiator however, the patent relates to non-soft materials and focusses on flame retardancy.

### Process

The process according to the invention comprises at least two steps. In a first step, also referred to as step a), a thermoplastic copolyester is mixed with a silicone elastomer and a radical initiator and optionally an adhesion additive. In a second step, also referred to as step b) the obtained mixture is vulcanized at an elevated temperature. These two steps may be performed sequentially, or simultaneously. According to the process of this invention, the thermoplastic resin is prepared by thoroughly mixing the silicone elastomer in the thermoplastic copolyester and dynamically vulcanizing the silicone elastomer.

“Elevated temperature” for purposes of this invention is at least the melt processing temperature of the thermoplastic copolyester. Preferably, the temperature is at least 10° C. above the melting temperature of the thermoplastic copolyester and above a temperature that activates the radical initiator whichever temperature is higher.

Mixing may be performed by known means such as for example employing an extruder.

For purposes of this invention, the weight ratio of silicone elastomer to the thermoplastic copolyester can range from 0.5:99.5 to 85:15.

Preferably, the weight content of silicone elastomer in the thermoplastic resin is between 5 and 30 wt %, more preferably between 10 and 25 wt %, and most preferred between 15 and 22 wt % wherein wt % is with respect to the total weight of the thermoplastic resin.

In one embodiment, the weight ratio of silicone elastomer to the thermoplastic copolyester is rather high, and thus also the content of silicone elastomer in the thermoplastic resin is kept rather high, such as for example between 40 and 70 wt %, with wt % being with respect to the total weight of the thermoplastic resin, after which the obtained thermoplastic resin is mixed with a further thermoplastic copolyester, thereby reducing the weight ratio of silicone elastomer to thermoplastic copolyester to the desired final ratio, and thus also the weight content of silicone elastomer in the thermoplastic resin. The further thermoplastic copolyester may be the same as employed in step a) but may also be different. Preferably, the thermoplastic copolyester is the same. This embodiment has as advantage that a concentrated thermoplastic resin may be prepared and subsequently diluted with a thermoplastic copolyester.

In another embodiment, the weight ratio of silicone elastomer to thermoplastic copolyester is chosen such that the weight ratio is as desired in the final product and no further thermoplastic copolyester is added. This embodiment has as advantage that no further dilution step is necessary.

### Thermoplastic Copolyester (A)

The thermoplastic copolyester as provided in step a) in the method according to the invention has a shore A hardness of less than 95. A copolyester comprises hard segments of a polyester and soft segments derived from another polymer. The hard segments are generally composed of monomeric units derived from at least one alkylene diol and at least one aromatic or cycloaliphatic dicarboxylic acid. The hard segments may for example be polyethylene terephthalate (PET) and/or polybutylene terephthalate (PBT). Preferably, the hard segment is PBT as this has the advantage that crystallization of PBT is faster, which enable shorter cycle times during processing of parts made from the composition. The amount of hard segments H is preferably between 10 and 70 wt %, in which wt % is based on the total mass of the thermoplastic copolyester as provided in step a). The exact amount of hard segments H depends on the desired properties such as the desired hardness of the thermoplastic copolyester.

The thermoplastic copolyester comprises soft segments derived from another polymer and may be chosen from a wide variety of polymers, such as polytetramethylene oxide (PTMO), polyethylene oxide (PEO), polypropylene oxide (PPO), block copolymers of poly(ethylene oxide) and poly(propylene oxide), linear aliphatic polycarbonates, polybutylene adipate (PBA) and derivates of dimer fatty acids (DFA) or dimer fatty acid diols, polyolefins, linear aliphatic polyesters and combinations thereof. An example of suitable linear aliphatic polycarbonates is polyhexamethylene carbonate (PHMC). Examples of suitable polyolefins are polyethylene (PE) and polypropylene (PP). Preferably, the soft segment is chosen from PTMO and DFA, as this has the advantage that they exhibit optimized polarity which provides an advantage in strain resistance.

The molecular mass of the soft segment is preferably between 500 g/mol and 4000 g/mol, more preferably between 1000 and 3000 g/mol as this has the advantage that phase separation during production of thermoplastic copolyester is minimized. The molar mass can be measured according to size exclusion chromatography or ¹H nuclear magnetic resonance (NMR) spectroscopy.

Preferably, the amount of soft segments S is between 30 and 90 wt %, in which wt % is based on the total mass of the thermoplastic copolyester as provided in step a). A higher amount of soft segments S results in a softer thermoplastic copolyester and has the advantage that the resulting thermoplastic copolyester has enhanced flexibility, elasticity, and yet retains strength for example relatively high tensile modulus combined with high elongation at break.

Preferably the number average molecular weight of the thermoplastic copolyester provided in step a) is at least 15 000 g/mol, more preferably at least 20 000 g/mol. A higher molecular weight has the advantage that mechanical integrity is enhanced. The maximum number average molecular weight of the thermoplastic copolyester is not particularly limited and may be as high as for example 60 000 g/mol and is usually limited by reactor capabilities in terms of mechanical stirring power. The thermoplastic copolyester can optionally be reacted further via solid state post-condensation to increase the molecular weight to a higher desired value before it is provided in step a).

The thermoplastic copolyester as provided in step a) may further contain minor amounts of other components such as branching agents, including but not limited to trimellitate linkages, derived from precursors such as for example trimethyl trimellitate, or any derivative thereof, which may be incorporated during production in minor amounts. Typically, these other components may be present in an amount of at most 10 wt %, more preferably in an amount at most 5 wt %, and most preferably at most 2 wt % based on the total mass of thermoplastic copolyester as provided in step a).

The thermoplastic copolyester as provided in step 1 has a shore A hardness of less than 95 as measured according to ISO 868 with measuring time of 3 sec and the materials were conditioned prior to measurement for 24 hrs at 23° C. and 50% RH, as this ensures that the obtained thermoplastic resin exhibits sufficient softness. Preferably, the thermoplastic copolyester as provided in step 1 has a shore A hardness of less than 90, more preferably less than 87 and most preferred less than 85. The lower the shore A hardness is of the thermoplastic copolyester as provided in step a), the softer the obtainable thermoplastic resin is with the method according to the invention.

The thermoplastic copolyester as provide in step a) may be prepared by polymerization reaction according to a variety of different methods, which are known per se to a person skilled in the art. Generally, the thermoplastic copolyester is prepared by mixing all precursors, either simultaneously or sequentially throughout the polymerization process, heating the mixture to a temperature until the mixture is in a molten state, such as for example at a temperature between 175° C. and 210° C. and subsequently applying a reaction temperature until the desired molecular weight of the thermoplastic copolyester is obtained, after which the thermoplastic copolyester may be cooled and optionally granulated. The reaction temperature usually is at least as high as the melting temperature of the thermoplastic copolyester, as the thermoplastic copolyester generally remains in a molten state until the desired molecular weight is obtained. Preferably, the temperature is maintained under reduced pressure to remove condensate.

### Silicone Elastomer (B)

The silicone elastomer (B) comprises a polydiorganosiloxane gum having a plasticity of at least 30 and having an average of at least 2 alkenyl groups per molecule and optionally comprising a reinforcing agent at levels of 0 to 50 parts by weight with respect to the polydiorganosiloxane gum, wherein the weight ratio of said silicone elastomer to said thermoplastic copolyester is from 0.5:99.5 to 85:15. The polydiorganosiloxane gum has a plasticity of at least 30, which can be measured according to ASTM D926-08.

Preferably, the amount of reinforcing agent in the silicone elastomer is low, such as for example at most 20 wt %, more preferably at most 10 wt %, even more preferred at most 7 wt % and even more preferred at most 5 wt %, with respect to the polydiorganosiloxane gum, as this improves the surface properties, such as scratch resistance. Most preferred there is substantially no reinforcing agent present in the silicone elastomer.

The polydiorganosiloxane gum is defined as ultra-high molecular weight polydiorganosiloxane having a molecular weight (Mn) of at least 10,000 g/mol and not more than about 1,000,000 g/mol (Mn). The organic groups of the polydiorganosiloxane are independently selected from hydrocarbon or halogenated hydrocarbon radicals such as alkyl and substituted alkyl radicals containing from 1 to 20 carbon atoms; alkenyl radicals, such as vinyl and 5-hexenyl; cycloalkyl radicals, such as cyclohexyl; and aromatic hydrocarbon radicals, such as phenyl benzyl and tolyl. Preferred organic groups are lower alkyl radicals containing from 1 to 4 carbon atoms, phenyl, and halogen-substituted alkyl such as 3,3,3-trifluoropropyl. Thus, the polydiorganosiloxane can be a homopolymer, a copolymer or a terpolymer containing such organic groups. Examples include polydiorganosiloxanes comprising dimethylsiloxy units and phenylmethylsiloxy units; dimethylsiloxy units and diphenylsiloxy units: and dimethylsiloxy units. diphenylsiloxy units and phenylmethylsiloxy units, among others. Most preferably, the polydiorganosiloxane is a polydimethylsiloxane which is terminated with a vinyl group at each end of its molecule and/or contains at least one vinyl group along its main chain, thus as a pendant group.

The optional and preferred reinforcing agent (E) is silica filler. The silica filler that may be employed in this invention are finely divided fillers derived from fumed or precipitated forms, or from silica aerogels. These fillers are well known and are typically characterized by surface areas greater than about 50 m2/gram. The fumed form of silica is the preferred reinforcing agent based on its availability, cost, and high surface area, which can be as high as 900 m2/gram, but preferably has a surface area of 50 to 400 m2/gram. These silicas are also very easy to manufacture and handle. It is contemplated within the scope of this invention to use a silicone elastomer that do not contain silica filler, or that contain very small amounts of silica filler. Thus, amounts of silica may range from zero parts per 100 parts of the silicone elastomer up to less than 1 part of silica filler can be used.

For purposes of this invention, the silica filler, if used, is preferably treated by reaction with a liquid organosilicon compound containing silanol groups or hydrolyzable precursors of silanol groups. Compounds that can be used as filler treating agents, also referred to as anti-creping agents, include such components as low molecular weight liquid hydroxy- or alkoxy-terminated polydiorganosiloxanes, hexaorganodisiloxanes and hexaorganodisilazanes. The silicon-bonded hydrocarbon radicals in or on a portion of the filler treating agent can contain substituents such as carbon to carbon double bonds. It is preferred that the treating compound is an oligomeric hydroxy-terminated polydimethyl-siloxane having an average degree of polymerization (DP) of about 2 to about 100. A highly preferred treating fluid of this type has a DP of about 2 to 10.

The silica filler, if used in the present method, can be reacted with about 10 to about 45 weight percent, based on silica filler weight, of the filler treating agent prior to being blended with the polydiorganosiloxane to form the silicone elastomer. Treatment of the silica filler can be carried out in the same mixing vessel used to prepare the silicone rubber. The silica or other reinforcing filler is typically maintained at a temperature greater than about 100 degrees centigrade to about 200 degrees centigrade during the treatment process. Alternatively, the filler can be treated while it is being blended with the high consistency polydiorganosiloxane during preparation of the silicone elastomer.

The preparation of the silicone elastomer useful in this invention can be found in U.S. Pat. No. 5,508,323, among others, and the disclosure with regard to this preparation is hereby incorporated by reference for what it teaches about such silicone elastomer preparation.

### Radical Initiator (C)

The radical initiators useful in this invention are any compounds capable of providing free radicals for the subsequent vulcanization of the silicone elastomer. Such radical initiators can be exemplified and selected from the group consisting of (i) 2,2′-azobisisobutyronitrile, (ii) 2,2′-azobis(2-methylbutyronitrile), (iii) dibenzoyl peroxide, (iv) tert-amyl peroxyacetate, (v) 1,4-di(2-tert-butylperoxyisoproyl)benzene, monohydroperoxide, (vi) cumyl hydroperoxide, (vii) tert-butyl hydroperoxide, (viii) tert-amyl hydroperoxide, (ix) 1,1-d(tert-butylperoxy)cyclohexane, (x) tert-butylperoxy isopropyl carbonate, (xi) tert-amyl peroxybenzoate, (xii) dicumyl peroxide, (xiii) 2,5-dimethyl-2,5-di-(tert-butylperoxy)hexane, (xiv) bis(1-methyl-1-phenylethyl)peroxide, (xv) 2,5-dimethyl-2,5-di-(tert-butylperoxy)hexyne-3, (xvi) di-tert-butyl peroxide, (xvii) a,a-dimethylbenzyl hydroperoxide, (xviii) 3,4-dimethyl-3,4-diphenylhexane, (xix) t-butyl hydroperoxide, (xx) t-butyl peroxy 0-toluate, (xxi) cyclic peroxy ketal, (xxii) t-butyl peroxypivalate, (xxiii) lauroyl peroxide, (xxiv) t-amyl peroxy-2-ethylhexanoate, (xxv) vinyltris(t-butyl peroxy)silane, (xxvi) di-t-butylperoxide, (xxvii) 2,2,4-trimethylpentyl-2-hydroperoxide, (xxviii) 2,5-bis(t-butylperoxy)-2,5-dimethylhexyne-3, (xxix) t-butyl-peroxy-3,55-trimethylhexanoate, (xxx) cumene hydroperoxide, (xxxi) t-butyl peroxybenzoate, (xxxii) diisopropylbenzene mono hydroperoxide, and (xxxiii) combinations of (i) to (xxxii). The preferred radical initiator is selected based on the melting Temperature™ of the thermoplastic copolyester. It is best to use a initiator based on a half-life greater than 20° C. above the Tm of the thermoplastic copolyester.

The radical initiator is used in an amount sufficient to cure polydiorganosiloxane gum (B) and this amount can be optimized for a given system by those skilled in the art using routine experimentation. When the amount is too low, insufficient crosslinking takes place and mechanical properties suffer accordingly. Optimum performance can be readily determined by a few simple experiments for the system under consideration. Moreover, information can be obtained from the manufacturer with regard to the performance (half-life) of the initiator.

The radical initiator is added in the amount of 0.01 to 5 wt % based on the weight of the silicone elastomer. More preferred is an amount of 0.05 to 4 wt %.

### (D) Optional Adhesion Additive

Also useful in this invention are adhesion additives (also known as coupling agents). Such additives and how they are used are well known in the art. For example, in U.S. Pat. No. 5,508,323 there is disclosed at column 6, beginning at line 16, a full disclosure of what these materials are and that information is incorporated herein by reference for what it teaches about such adhesion additives and how they are used. Preferably, the adhesion additive (D) comprises a polyolefin comprising an acrylate, maleic anhydride, and/or acid functionality.

Preferred for this invention is the use of a level of adhesion additive of about 0.5 to about 15 wt % with respect to the weight of said silicone elastomer, the addition being preferably carried out after the polydiorganosiloxane gum and treated silica filler have been mixed.

### Further Ingredients

Also contemplated within the scope of this invention is the use of fire retardant additives to provide fire retardancy to the compositions of this invention. Fire retardants may be added to the thermoplastic copolyester prior to step a) and/or during step a) and/or step b) or after step b). Traditional fire retardants can be used herein and can be selected from the group consisting of halogenated varieties such as polydibromostyrene, copolymers of dibromostyrene, polybromostyrene, brominated polystyrene, tetrabromophthalate esters, tetrabromophthalate diol, tetrabromophthalate anhydride, tetrabromobenzoate ester, hexabromocyclododecane, tetrabromobisphenol A, tetrabromobisphenol A bis(2,3-dibromopropyl ether), tetrabromobisphenol A bis(allyl ether), phenoxy-terminated carbonate oligomer of tetrabromobisphenol A, decabromodiphenylethane, decabromodiphenyl oxide, bis-(tribromophenoxyl)ethane, ethane-1,2-bis(pentabromophenyl), tetradecabromodiphenoxybenzene, ethylenebistetrabromophthalimide, ammonium bromide, poly pentabromobenzyl acrylate, brominated epoxy polymer, brominated epoxy oligomer, and brominated epoxies. Other, non-halogen varieties can be selected from such materials as triaryl phosphates isopropylated, cresyl diphenyl phosphate, tricresyl phosphate, trixylxl phosphate, triphenylphosphate, triaryl phosphates butylated, resorcinol bis-(diphenyl phosphate), bisphenol A bis(diphenyl phosphate), Aluminium diethyl phosphinate, melamine phosphate, melamine pyrophosphate, melamine polyphosphate, dimelamine phosphate, melamine, melamine cyanurate, magnesium hydroxide, antimony trioxide, red phosphorous, zinc borate, and zinc stanate.

It is known by those skilled in the art with regard to how much of the fire retardant can be added to give the required effect. Those amounts are also useful herein.

The thermoplastic copolyester as provided in step a) may also be provided as a composition comprising the thermoplastic copolyester and further additives. The further additives may also be added during the process according to the invention and/or added to the thermoplastic resin as obtained with the process according to the invention in a subsequent compounding step.

Further additives are for example stabilizers, catalysts, nucleating agents, including but not limited to titanium tetrabutoxide, talcum, anti-oxidants, such as for example 1,3,5-trimethyl-2,4,6-tris(3,5-di-tert-butyl-4-hydroxybenzyl)-benzene (commercially available as Irganox 1330), fillers, such as for example glass fibers and carbon fibers, as well as the above-mentioned fire retardants.

### Hardness

Surprisingly, with the process according to the invention it is possible to have a thermoplastic resin which exhibits good tear resistance. Another advantage is that also stain resistance is improved with respect to for example denim blue liquid and coffee, as compared to the thermoplastic copolyester as provided in step a). Also scratch resistance is improved as compared to the thermoplastic copolyester as provided in step a).

The invention thus also relates to a thermoplastic resin obtained by the process. The thermoplastic resin obtained by the process has a shore A hardness which is lower than the shore A hardness of the thermoplastic copolyester as provided in step a), and preferably has a shore A hardness of less than 90, more preferably less than 80 and even more preferred less than 75, most preferred less than 72.

As elaborated above, the thermoplastic resin as obtained by the process may be employed as such or in combination with further additives. The thermoplastic resin may be further processed in processes known per se, such as injection molding, blow molding, film extrusion, such as cast and blown film process, 3D printing processes such as fused deposition modeling, as well as other processes.

The invention also relates to a thermoplastic resin comprising as dispersed phase a silicone elastomer compound comprising a radically cross-linked polydiorganosiloxane and as continuous phase a copolyester compound comprising a thermoplastic copolyester, wherein the weight ratio of the continuous phase to the dispersed phase is from 99.5:0.5 to 15:85, wherein the dispersed phase may comprise up to 50 wt % by weight of a reinforcing agent. Preferably, the thermoplastic resin further comprises an adhesion additive (D) as elaborated above. Preferably, the thermoplastic resin has a shore A hardness of less than 90, more preferably less than 80 and even more preferred less than 75, most preferred less than 72. Preferably, the thermoplastic resin comprises as continuous phase a copolyester compound comprising a thermoplastic copolyester comprising hard segments of PET and/or PBT, preferably PBT as this has the advantage that crystallization of PBT is faster, which enable shorter cycle times during processing of parts made from the composition. The preferred embodiments relating to the soft segments of the thermoplastic copolyester as elaborated above, are also applicable for the thermoplastic resin according to the invention. Preferably, the thermoplastic copolyester in the thermoplastic resin comprises hard segments of PBT and/or PET and soft segments chosen from polytetramethylene oxide (PTMO), polyethylene oxide (PEO), polypropylene oxide (PPO), block copolymers of poly(ethylene oxide) and poly(propylene oxide), linear aliphatic polycarbonates, polybutylene adipate (PBA) and derivates of dimer fatty acids or dimer fatty acid diols, polyolefins, linear aliphatic polyesters and combinations thereof.

### Applications

With the process according to the invention it is possible to provide a thermoplastic resin which can be employed in many applications, especially in applications in which a high degree of softness is required, such as wearables and other soft goods. These applications include for example straps, covers for various apparatus, ear plugs, cables

The advantages of employing the thermoplastic resin as obtained by the process of the invention in these applications is that improved softness may be combined with high stain resistance and/or tear resistance, and/or scratch resistance. Also sufficient UV stability may be obtained.

Other applications include, but not limited to, film applications, conveyor belts, footwear, 3D printing filaments and powders, wire and cable coatings, automotive interiors, and medical devices.

### EXAMPLES

### Materials

(A) thermoplastic copolyester: thermoplastic copolyester containing 75 wt % of soft segment being PTHF with Mw 3000 g/mol and 25 wt % of hard segment being PBT, wherein wt % is with respect to the total weight of thermoplastic copolyester.

(A1) thermoplastic copolyester: thermoplastic copolyester containing 40 wt % of soft segment being dimerised fatty acid and 60 wt % of hard segment being PBT, wherein wt % is with respect to the total weight of thermoplastic copolyester.

The silicone elastomer (B) was a polydiorganosiloxane gum having an Mn of 60,000 and having 300 ppm of a vinyl functionality with 5 wt % of a precipitated silica having a surface area of 250 m²/g as reinforcing agent and the radical initiator (C) was 0.1 wt % of a dicumyl peroxide, based on the weight of the silicone elastomer.

The adhesion additive (D) was a polyethylene based tertpolymer having functionality of methyl acrylate and glycidyl methacrylate.

Thermoplastic resin with 10 wt % and 20 wt % of silicone elastomer, wherein wt % is with respect to the thermoplastic resin were prepared as follows: 89 wt % of thermoplastic copolyester (A), 1 wt % adhesion additive (D), 9.9 wt % silicone elastomer (B) and 0.1 wt % of a radical initiator (C), in which wt % is with respect to the total weight of thermoplastic resin, were mixed and dynamically vulcanized using an extruder at a temperature of about 200° C.

78 wt % thermoplastic copolyester (A), 2 wt % adhesion additive (D), 19.8 wt % silicone elastomer (B), and 0.2 wt % of a radical initiator (C), in which wt % is with respect to the total weight of thermoplastic resin, were mixed and dynamically vulcanized using an extruder at a temperature of about 200° C.

Thermoplastic resin with thermoplastic copolyester (A1) and 9.9 wt % and 14.85 wt % of silicone elastomer, wherein wt % is with respect to the thermoplastic resin were prepared as follows:

89.5 wt % of thermoplastic copolyester (A1), 0.5 wt % adhesion additive (D), 9.9 wt % silicone elastomer (B) and 0.1 wt % of a radical initiator (C), in which wt % is with respect to the total weight of thermoplastic resin, were mixed and dynamically vulcanized using an extruder at a temperature of about 200° C.
83 wt % thermoplastic copolyester (A1), 2 wt % adhesion additive (D), 14.85 wt % silicone elastomer (B), and 0.15 wt % of a radical initiator (C), in which wt % is with respect to the total weight of thermoplastic resin, were mixed and dynamically vulcanized using an extruder at a temperature of about 200° C.

A blend of thermoplastic copolyester (A) and 17 wt % of epoxidized soybean oil (ESO), wt % with respect to the total weight of the blend, was prepared by mixing the thermoplastic copolyester and the plasticizer using an extruder at a temperature of about 195° C.

TPSiV® 4000-70A thermoplastic elastomer: Commercially available, TPU-based material.

### Measured Properties

### Shore a Hardness:

Hardness has been measured on a Shore A scale according to the norm ISO 868. Prior to the measurement samples were conditioned for 24 hrs at 23° C. and 50% rel. humidity. Measuring time was 3 sec.

### Tensile Properties:

Tensile properties were measured according to the norm ISO527/1BA. Test temperature was 23° C. Prior to test tensile bars were conditioned for 24 hrs at ambient conditions (23° C. and 50% rel. humidity). Test speed was 500 mm/min for tensile stress and strain.

### Scratch Resistance Test:

An inhouse scratch performance evaluation was performed using a Falex scratch tester with a spherical ruby ball indenter. A fixed normal load was applied and then a 20 mm long scratch was made at 10 mm/sec. The applied loads were varied between (1, 2.5, 5, 10 N) with indenters of diameter 2 or 5 mm. Samples were injection molded plates (120 mm×120 mm×2 mm) with smooth surface. After scratches were made for the different diameters and applied loads, they were rated by how visible the scratches were by three people. Testing was performed at ambient conditions (23 C and 50% rel. humidity). ++ denotes highest scratch resistance, thus lowest amount of scratches visible, and 0 denotes worst scratch resistance, thus high amount of scratches visible.

### Tear Strength Test:

Tear strength has been measured according to the norm ISO 34/Method A. Samples were 2 mm thick. Test speed for tear strength test was 100 mm/min. Tear strength has been measured both in flow direction and transverse direction. The load at yield point was regarded as tear strength, which is not consistent with conception of method A.

### Spiral Flow Measurement:

Samples were injection molded at three different pressures: 800, 1000 and 1200 bar into a predefined G-shaped mold. Melt temperature was 190° C., mold temperature 40° C. and injection speed 30 mm/s. Spiral flow length was determined and results are given in Table 1.

Stain resistance test discoloration ASTM E308/F2:

Color ((L, a and b according to ASTM E308/F2) of material was measured prior to and after staining. Color change, delta E, was then calculated using following formula:

ΔE*=[(ΔL)²+(Δa)²+(Δb)²]^{1/2}.

Dye was poured into cup and samples were submerged into dye for 5 min and 30 min. After submerging, samples were wiped and dried with a dry cloth. Colors were again measured and samples were weighed. Color change (delta E) is provided in Table 1. Dye used was RIT® Liquid Dye Denim Blue.

TABLE 1
Results

| | | Comparative | | | |
|---|---|---|---|---|---|
| | | A1 | Example 1 | Example 2 | Example 3 |
| | Comparative A | Thermoplastic | (A) + 9.9 wt % | (A) + 19.8 wt % | (A1) + 9.9 wt % |
| | Thermoplastic | copolyester | silicone | silicone | silicone |
| | copolyester (A) | (A1) | elastomer | elastomer | elastomer |
| Properties | | | | | |
| Hardness Shore A | 82 | | 78 | 67 | |
| Hardness Shore D | 23 | 45 | | | 37 |
| Modulus [MPa] | 19 | 85 | 13 | 11 | |
| Tear strength flow | 44 | | 32 | 21 | 41 |
| direction [N/mm] | | | | | |
| Tear strength | 45 | | 34 | 22 | 54 |
| transverse direction | | | | | |
| [N/mm] | | | | | |
| Scratch resistance | 0 | | Not measured | ++ | |
| Stain resistance of | 2.6 | | | 1.0 | |
| liquid denim blue dye | | | | | |
| 5 min; delta E | | | | | |
| Stain resistance of | 3.6 | | | 2.4 | |
| liquid denim blue dye | | | | | |
| 30 min; delta E | | | | | |
| Spiral flow length at | 10.6 | | | 13.2 | |
| 800 bar [cm] | | | | | |
| Spiral flow length at | 12.2 | | | 16.2 | |
| 1000 bar [cm] | | | | | |
| Spiral flow length at | 15.0 | | | 18.5 | |
| 1200 bar [cm] | | | | | |

| | Example 4 | | |
|---|---|---|---|
| | (A1) + 14.85 wt % | Comparative B | Comparative C |
| | silicone | Blend of (A) | TPSiV ® 4000- |
| | elastomer | with plasticizer | 70A |
| Properties | | | |
| Hardness Shore A | | 67 | 68 |
| Hardness Shore D | 35 | | |
| Modulus [MPa] | | 10 | |
| Tear strength flow | 40 | 34 | 14 |
| direction [N/mm] | | | |
| Tear strength | 54 | 33 | 16 |
| transverse direction | | | |
| [N/mm] | | | |
| Scratch resistance | | 0 | + |
| Stain resistance of | | | |
| liquid denim blue dye | | | |
| 5 min; delta E | | | |
| Stain resistance of | | | |
| liquid denim blue dye | | | |
| 30 min; delta E | | | |
| Spiral flow length at | | 12.6 | 7.4 |
| 800 bar [cm] | | | |
| Spiral flow length at | | 15.5 | 9.3 |
| 1000 bar [cm] | | | |
| Spiral flow length at | | 18.4 | 11.2 |
| 1200 bar [cm] | | | |

The results in Table 1 clearly show that with the method according to the present invention a thermoplastic resin may be obtained, which combines softness (lower Shore A hardness) in combination with sufficient tear strength, and scratch resistance. When compared to a blend, the scratch resistance is much better with the method according to the invention. When compared with the commercially available TPSiV® solution, the tear strength was much better with the method according to the invention.

1. Process for preparing a thermoplastic resin comprising the following steps:
a) mixing:
a thermoplastic copolyester (A) having a shore A hardness of less than 95; and
a silicone elastomer (B) comprising a polydiorganosiloxane gum having a plasticity of at least 30 and having on average at least 2 alkenyl groups per polymeric chain and optionally a reinforcing agent in the range of 0 to 50 wt % based on the weight of the polydiorganosiloxane gum; and
a radical initiator (C) in an amount of 0.01 to 5 wt % based on the weight of the silicone elastomer; and
optionally an adhesion additive (D);
wherein the weight ratio of the silicone elastomer to the thermoplastic copolyester (B:A) is from 15:85 to 99.5:0.5;
b) dynamically vulcanizing the silicone elastomer in the thermoplastic copolyester at an elevated temperature.

2. Process according to claim 1, wherein the silicone elastomer (B) comprises a reinforcing agent being a silica filler.

3. Process according to claim 1, wherein the thermoplastic copolyester comprises hard segments of polyethylene terephthalate (PET) and/or polybutylene terephthalate (PBT).

4. Process according to claim 1, wherein the thermoplastic copolyester comprises soft segments chosen from polytetramethylene oxide (PTMO), polyethylene oxide (PEO), polypropylene oxide (PPO), block copolymers of polyethylene oxide) and polypropylene oxide), linear aliphatic polycarbonates, polybutylene adipate (PBA) and derivates of dimer fatty acids or dimer fatty acid diols, polyolefins, linear aliphatic polyesters and combinations thereof.

5. Process according to claim 1, wherein the content of silicone elastomer in the thermoplastic resin is between 5 and 30 wt %, with wt % being with respect to the total weight of the thermoplastic resin.

6. Process according to claim 1, wherein the adhesion additive (D) comprises a polyolefin comprising an acrylate, maleic anhydride, and/or acid functionality.

7. Process according to claim 1, wherein the polydiorganosiloxane gum has a molecular weight (Mn) of at least 10,000 g/mol and not more than 1,000,000 g/mol.

8. Process according to claim 1, wherein the polydiorganosiloxane gum comprises organic groups being alkyl and substituted alkyl radicals, alkenyl radicals, cycloalkyl radicals, aromatic hydrocarbon radicals and combinations thereof.

9. Process according to claim 1, wherein the polydiorganosiloxane gum is terminated with a vinyl group and/or contains at least one vinyl group as a pendant group

10. Thermoplastic resin prepared by the process according to claim 1.

11. Thermoplastic resin comprising as dispersed phase a silicone elastomer compound comprising a radically cross-linked polydiorganosiloxane and as continuous phase a copolyester compound comprising a thermoplastic copolyester
wherein the weight ratio of the continuous phase to the dispersed phase is from 99.5:0.5 to 15:85, wherein the dispersed phase may comprise up to 50% by weight of a reinforcing filler.

12. Thermoplastic resin according to claim 10, wherein the thermoplastic resin has a shore A hardness of less than 80.

13. Thermoplastic resin according to claim 11, wherein the thermoplastic copolyester comprises hard segments of PBT and/or PET and soft segments chosen from polytetramethylene oxide (PTMO), polyethylene oxide (PEO), polypropylene oxide (PPO), block copolymers of poly(ethylene oxide) and poly(propylene oxide), linear aliphatic polycarbonates, polybutylene adipate (PBA) and derivates of dimer fatty acids or dimer fatty acid diols, polyolefins, linear aliphatic polyesters and combinations thereof.

14. Soft goods comprising the thermoplastic resin of claim 10.
